(19) United States
(12) Patent Application Publication
(10) Pub. No.: US 2024/0007290 A1
(43) Pub. Date: Jan. 4, 2024

(54) SYSTEMS AND METHOD FOR DETERMINING QUALITIES OF NON-FUNGIBLE TOKENS

(71) Applicant: KEENWAWA, INC., San Francisco, CA (US)

(72) Inventors: Felix E. Dulys, Seattle, WA (US); Benjamin W. Straley, Seattle, WA (US)

(21) Appl. No.: 17/853,900

(22) Filed: Jun. 29, 2022

(51) Int. Cl. H04L 9/32; H04L 9/00

(52) U.S. Cl. CPC H04L 9/3213; H04L 9/50; H04L 2209/603

(57) ABSTRACT

Methods and compositions for determining qualities of ODAs are provided. In some embodiments, the compositions comprise a blockchain analysis system and a distributed blockchain network comprising a plurality of nodes. In some embodiments, the blockchain analysis system comprises a processor and a non-transitory computer readable medium for storing one or more instructions. In some embodiments, when executed, the instructions may cause the processor to (1) receive ownership data corresponding to ownership of one or more ownable digital assets through the plurality of nodes; (2) generate a network distribution of node weights based at least in part on the ownership data; (3) determine an ownable digital asset recommendation based on one or more factors, the one or more factors comprising a first factor based at least in part on the network distribution of node weights; and (4) send recommendation data to a user corresponding to the ownable digital asset recommendation.

### TECHNICAL FIELD

The present disclosure relates to ownable digital assets, and more particularly, to determining the quality, trustworthiness, usefulness, and/or user-specific desirability of a non-fungible token via a network distribution.

### BACKGROUND

Ownable digital assets (“ODAs”), such as non-fungible tokens (“NFTs”) have gained significant traction in digital marketplaces. Though NFTs originally gained popularity as a means to protect ownership of digital images, they have expanded to see considerable use in the fields of music, videos, sports cards, video game assets, medical records, membership status indicators, authentication for smart contracts, and more. Social media platforms, NFT indexes, and NFT marketplaces have been created to facilitate NFT exchange and the NFT community. However, despite NFTs' recent successes, a significant quality issue persists. Rug pulls and counterfeit NFT scams remain rampant, harming collectors', brands', and creators' ability to safely connect and exchange NFTs.

### SUMMARY

Embodiments of the present disclosure are generally directed to ownable digital assets, and more particularly, to determining the quality, trustworthiness, usefulness, and/or user-specific desirability of a non-fungible token via a network distribution. In certain embodiments, a network distribution (for example, and without limitation, a network visualization) of a collection of NFTs may be generated. The network distribution may apply a weight to a node based on the number of NFTs in the collection that a given digital wallet owns. Different NFT collection qualities may correspond to different network visualizations of nodes—for example, high-quality NFT collections with active communities may display graphically with an asymmetric shape, multi-directional edges, and/or a high degree of variation of node weights. Conversely, low-quality NFT collections with inactive communities and scam collections may display graphically with a symmetric shape, uni-directional edges, and/or a low degree of variation of node weights. In certain embodiments, a blockchain analysis system may assign values to NFT collections based on their corresponding network distributions and may present a user interface to a user. In certain embodiments, the user interface may present as a ranking of NFTs based on one or more of the NFTs' assumed quality, trustworthiness, and suitability for the user. The blockchain analysis system may interpret suitability for the user based on one or more of the user's ODA ownership history, search history, stated preferences, and wallet value. In certain embodiments, the blockchain analysis system may identify and/or cluster ODAs in classes or groups to support discovery and/or exchange.

The present disclosure embodies several unique advantages. For example, the blockchain analysis system may improve collectors', creators', and brands' ability to transact via NFTs and other ODAs by reducing the risk of exposure to fraudulent behavior. Furthermore, users may efficiently discover NFTs that suit their preferences. Additionally, the blockchain analysis system may operate across any distributed ledger blockchain (for example, and without limitation, Ethereum and Solana), and a single search may pull results from multiple platforms. The systems and methods disclosed herein are not limited to post-exchange ODA collections; rather, many of the embodiments disclosed herein may be utilized to discover high-quality, trustworthy, useful, and/or user-tailored ODAs before, at, or after an ODA's minting date. These and other advantages of the systems and methods of the present disclosure may be used to increase the efficiency and safety of ODA transactions.

Embodiments of the present disclosure are generally directed at a system for determining one or more qualities of an ownable digital asset. In some non-limiting embodiments, the system includes at least one distributed blockchain network and a blockchain analysis system. The at least one distributed blockchain network includes a plurality of nodes. The blockchain analysis system includes a processor and a non-transitory computer readable medium for storing one or more instructions that, when executed, cause the processor to: (1) receive ownership data corresponding to ownership of one or more ownable digital assets through the plurality of nodes; (2) generate a network distribution of node weights based at least in part on the ownership data; (3) determine an ownable digital asset recommendation based at least in part on one or more factors, the one or more factors including a first factor based at least in part on the network distribution of node weights; and (4) send recommendation data to a user corresponding to the ownable digital asset recommendation.

In some non-limiting embodiments, the one or more factors further include data received from a user node corresponding to a user and one or more user inputs. In some non-limiting embodiments, the one or more user inputs correspond to one or more of the user's stated preferences and the user's search history. In some non-limiting embodiments, the data received from the user node corresponds to one or more of the user's history of ownable digital asset ownership and an economic value of the user's digital wallet. In some non-limiting embodiments, the recommendation data includes a ranking of ownable digital assets. In some non-limiting embodiments, the ownership data is received, at least in part, by discovering nodes through an initial sample of seed nodes. In some non-limiting embodiments, the network distribution is not displayed on a user interface. In some non-limiting embodiments, the ownable digital asset is a non-fungible token.

Other embodiments of the present disclosure are directed at a method for generating ODA recommendation data. In some non-limiting embodiments, the method includes receiving, using a network interface, ownership data corresponding to ownership of one or more ownable digital assets through a plurality of nodes. The method further includes generating, using a processor, a network distribution of node weights based at least in part on the ownership data. The method further includes determining, using the processor, an ownable digital asset recommendation based at least in part on one or more factors, the one or more factors comprising a first factor based at least in part on the network distribution of node weights. The method further includes sending to a user, using the network interface, recommendation data corresponding to the ownable digital asset recommendation.

In some non-limiting embodiments, the one or more factors further include one or more of (1) data received from a user node corresponding to the user; and (2) one or more user inputs. In some non-limiting embodiments, the one or more user inputs correspond to one or more of the user's stated preferences and the user's search history. In some non-limiting embodiments, the data received from the user node corresponds to one or more of the user's history of ownable digital asset ownership and an economic value of the user's digital wallet. In some non-limiting embodiments, the recommendation data includes a ranking of ownable digital assets. In some non-limiting embodiments, the ownership data is received, at least in part, by discovering nodes through an initial sample of seed nodes. In some non-limiting embodiments, the network distribution is not displayed on a user interface.

Other embodiments of the present disclosure are directed at a server. In some non-limiting embodiments, the server includes a memory and a processor. The memory is operable to store a user account associated with a user. The processor is communicatively coupled to the memory, the memory including executable instructions that, upon execution by the processor, cause the server to: (1) receive ownership data corresponding to ownership of one or more ownable digital assets through a plurality of nodes; (2) generate a network distribution of node weights based at least in part on the ownership data; (3) determine an ownable digital asset recommendation based at least in part on one or more factors, the one or more factors comprising a first factor based at least in part on the network distribution of node weights; and (4) send recommendation data to a user corresponding to the ownable digital asset recommendation.

In some non-limiting embodiments, the one or more factors further include one or more of: (1) data received from a user node corresponding to the user; and (2) one or more user inputs. In some non-limiting embodiments, the one or more user inputs correspond to one or more of the user's stated preferences and the user's search history. In some non-limiting embodiments, the data received from the user node corresponds to one or more of the user's history of ownable digital asset ownership and an economic value of the user's digital wallet. In some non-limiting embodiments, the recommendation data comprises a ranking of ownable digital assets. In some non-limiting embodiments, the ownership data is received, at least in part, by discovering nodes through an initial sample of seed nodes. In some non-limiting embodiments, the network distribution is not displayed on a user interface. In some non-limiting embodiments, the ownable digital asset is a non-fungible token.

These and other features and characteristics of the disclosed systems and methods for determining qualities of ODAs will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular forms of “a”, “an”, and “the” include plural referents unless the context clearly dictates otherwise.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a first block diagram illustrating ODA transactions between digital wallets, according to one or more embodiments;

FIG. 2A is a second block diagram illustrating ODA transactions between digital wallets, according to one or more embodiments;

FIG. 2B is a subset of the second block diagram of FIG. 2A, illustrating a single collection's ODA transactions between digital wallets, according to one or more embodiments;

FIG. 3 is a first network visualization illustrating trustworthy ODA transactions between digital wallets, according to one or more embodiments;

FIG. 4 is a network visualization illustrating untrustworthy ODA transactions between digital wallets, according to one or more embodiments;

FIG. 5A is a second network visualization illustrating trustworthy ODA transactions between digital wallets, according to one or more embodiments;

FIG. 5B is a subset of the second network visualization of FIG. 5A, illustrating a bowtie-shaped network visualization of ODA transactions between digital wallets, according to one or more embodiments;

FIG. 6 is a third network visualization illustrating trustworthy ODA transactions between digital wallets, according to one or more embodiments;

FIG. 7 is a fourth network visualization illustrating trustworthy ODA transactions between digital wallets, according to one or more embodiments;

FIG. 8 is a block diagram illustrating the flow of data in an ODA recommendation system, according to one or more embodiments; and

FIG. 9 is a block diagram illustrating components of an example control server, according to one or more embodiments.

### DETAILED DESCRIPTION

For purposes of the description hereinafter, it is to be understood that the disclosure may assume alternative variations and step sequences, except where expressly specified to the contrary. It is also to be understood that the specific devices and processes illustrated in the attached drawings and described in the following specification are simply exemplary aspects of the disclosure. Hence, specific dimensions and other physical characteristics related to the aspects disclosed herein are not to be considered as limiting.

As used herein, the term “coupled” should be understood to include any direct or indirect connection between two things, including, and without limitation, a physical connection (including, and without limitation, a wired or mechanical connection), a non-physical connection (including, and without limitation, a wireless connection), a fluid connection (including, and without limitation, a connection allowing for fluid communication), or any combination thereof. Furthermore, the words “comprising” (and any form of comprising, such as “comprise” and “comprises”), “having” (and any form of having, such as “has” and “have”), “including” (and any form of including, such as “includes” and “include”) or “containing” (and any form of containing, such as “contains” and “contain”) are to be understood as inclusive and open-ended and do not exclude additional, unrecited elements or method steps.

As used herein, the term “at least one of” is synonymous with “one or more of.” For example, the phrase “at least one of A, B, and C” means any one of A, B, and C, or any combination of any two or more of A, B, and C. For example, “at least one of A, B, and C” includes one or more of A alone; or one or more of B alone; or one or more of C alone; or one or more of A and one or more of B; or one or more of A and one or more of C; or one or more of B and one or more of C; or one or more of all of A, B, and C. Similarly, as used herein, the term “at least two of” is synonymous with “two or more of.” For example, the phrase “at least two of D, E, and F” means any combination of any two or more of D, E, and F. For example, “at least two of D, E, and F” includes one or more of D and one or more of E; or one or more of D and one or more of F; or one or more of E and one or more of F; or one or more of all of D, E, and F.

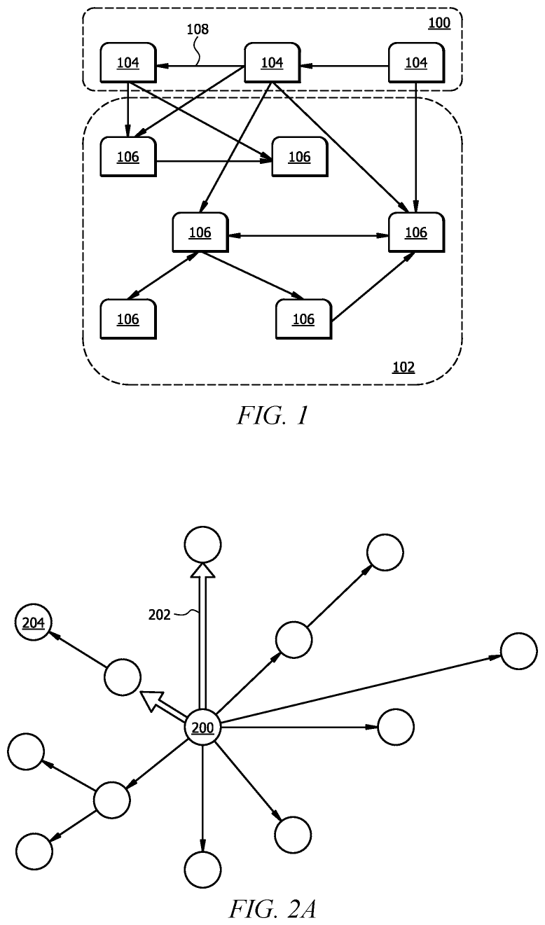

FIG. 1 is a first block diagram illustrating ODA transactions between digital wallets, according to one or more embodiments of the present disclosure. In certain embodiments, data may be visualized between two subsets of digital wallets: a set of seed wallets 100 and a set of non-seed wallets 102. One or more seed wallets 104 may execute one or more transactions 108 of ODAs (for example, and without limitation, NFTs). The one or more transactions 108 may be with one or more other seed wallets 104, one or more non-seed wallets 106, or any combination thereof. Similarly, non-seed wallets 106 may execute one or more transactions 108 with one or more other non-seed wallets 106, one or more seed wallets 104, or any combination thereof. In certain embodiments, data representing the transactions 108 between wallets may be visualized in a manner similar to that of FIG. 1. However, those having skill in the art will understand that FIG. 1 depicts one of many visualization methods falling within the scope of the present disclosure, and it is within the ability of a person having skill in the art to select an appropriate visualization method.

In certain embodiments, a system may be implemented for determining one or more qualities of an ownable digital asset. For example, and without limitation, a system may generate a network representation of an ODA collection's transactions and/or ownership. The system may gather data in order to produce the network representation. In certain embodiments, the data may be gathered by analyzing ownership data from a plurality of nodes on a distributed blockchain network. As used herein, the term “ownership data” means data based at least in part on (1) current ownership of ODAs (including, and without limitation, cryptocurrencies, NFTs, and other assets capable of being transferred on a blockchain); (2) ownership history of ODAs; (3) transactions of ODAs; or (4) any combination thereof.

In certain embodiments, the ownership data may be received, at least in part, by discovering nodes through an initial sample of seed nodes. A “seed node” is a node used by the system to discover other nodes through the seed node's ownership data. A seed wallet is a type of seed node; it is a digital wallet used by the system to discover other nodes (including, and without limitation, other digital wallets). The one or more seed nodes may be selected for any reason. In certain embodiments, the one or more seed nodes may be selected because they are deemed to be especially trustworthy or high-quality. In certain embodiments, the one or more seed nodes may be selected because they are the most easily accessible to the system. In certain embodiments, the one or more seed nodes may be selected at random. These examples are purely exemplary and do not limit the scope of the present disclosure.

Based at least in part on the network representation, the system may determine one or more qualities about the ODA collection (for example, and without limitation, the system may determine the ODA collection's trustworthiness, quality, demand, suitability to the user, or any combination thereof). In certain embodiments, one or more ODA recommendations may be generated for the user to view. The generated ODA recommendations may appear on a user interface. In certain embodiments, the ODA collection may be an NFT collection.

Certain embodiments of the present disclosure may operate on one or more blockchain networks. For example, and without limitation, some embodiments may operate primarily, or exclusively, on the Ethereum blockchain, Solana blockchain, Tezos blockchain, Flow blockchain, WAX blockchain, BSC blockchain, one or more other blockchains (including, and without limitation, private blockchains), or any combination thereof. In certain other embodiments, the system may gather data from any and all available sources. These examples are purely exemplary and non-limiting; the system may operate based at least in part on data from at least one blockchain. In certain embodiments, a user may use a user interface to execute an ODA search. In certain embodiments, a processor may analyze data across one or more blockchains or other platforms in response to the user's search. In certain embodiments, a user interface may display ODAs held on multiple blockchains in response to the user's search. In certain other embodiments, the user interface may display ODAs held on a single blockchain in response to the user's search.

The data collected by the system may be collected with or without the use of a crawler. A crawler is not strictly necessary for practicing some embodiments of the present disclosure because blockchain transactions are typically public information. Data may be indexed to identify one or more relationships between one or more senders of at least one ODA and one or more receivers of at least one ODA.

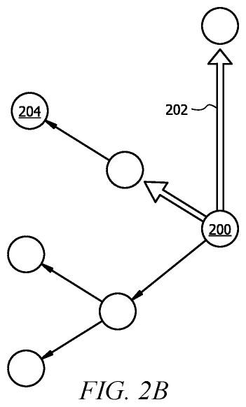

FIG. 2A is a second block diagram illustrating ODA transactions between digital wallets, according to one or more embodiments of the present disclosure. One or more nodes 204 may transact 202 with one or more other nodes 204. One or more nodes 204 may be a seed node 200. In certain embodiments (such as the embodiment depicted in FIG. 2A), a seed node 200 may be a “god node,” or a single node from which all or almost all transactions may be traced. In certain embodiments, a node may be a digital wallet.

FIG. 2B is a subset of the second block diagram of FIG. 2A, illustrating a single collection's ODA transactions between digital wallets, according to one or more embodiments of the present disclosure. In certain embodiments, a subset of a network visualization of ODA transactions (like that of FIG. 2A) may be generated to show a subset of the transactions 202, such as the ODAs from a single collection. In certain embodiments, a collection of ODAs may represent some or all ODAs produced by a single source. In certain embodiments, a collection of ODAs may appear on the blockchain at the same time or near the same time.

In certain embodiments, a network distribution or network visualization may be a mathematical directed graph created from one or more ODA-related transactions on a blockchain. In certain embodiments, one or more nodes may be virtual wallets. In certain embodiments, one or more transactions between wallets containing one or more ODAs may take the form of “arcs” between the wallets. Transactions may be evaluated at the token level, and a collection may contain many tokens.

A network distribution or network visualization may be filtered to contain only wallets (nodes) and transactions (arcs) for one collection. When a network distribution or network visualization is filtered in this way, one or more values may be weighted, averaged, and/or aggregated to produce a derivative score. In certain embodiments, a derivative score may be used to evaluate a collection.

The term “network visualization” as used herein is a subset of the term “network distribution.” All network visualizations are network distributions. A network distribution is a network visualization if it is prepared in a manner suitable to be displayed on a screen. For example, and without limitation, a network visualization may be presented as a graph.

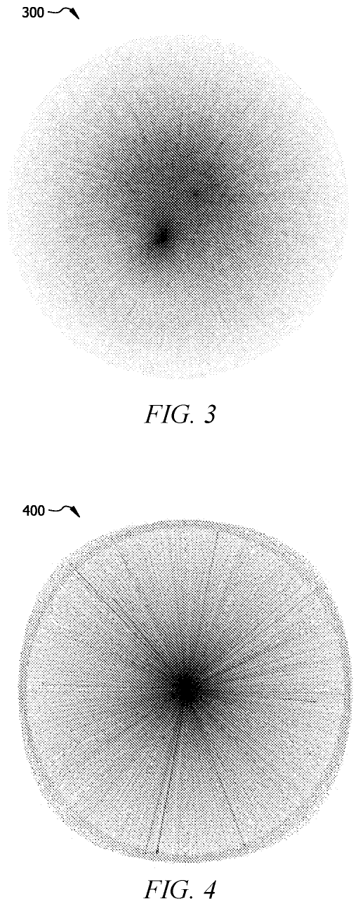

FIG. 3 is a first network visualization 300 illustrating trustworthy ODA transactions between digital wallets, according to one or more embodiments of the present disclosure. In certain embodiments, one or more network visualizations like those of FIGS. 3-7 may be generated to analyze one or more patterns and/or metrics that indicate one or more of the quality, influence, demand, and trustworthiness, of an ODA. Figures like those of FIGS. 3-7 may be analyzed by a person, an application, or any combination thereof. In certain embodiments, a machine learning algorithm may be used.

In certain embodiments, darkness in a network representation may indicate a high number of nodes, a high number of ODAs owned, and/or a high number of transactions. In certain embodiments, one network representation may correspond to a single ODA collection. FIGS. 3-7 conform to the descriptions presented in this paragraph. However, the descriptions of this paragraph and FIGS. 3-7 are purely exemplary. Any method of generating a network representation of ODA ownership data may be used without departing from the scope of the present disclosure, and it is within the ability of one skilled in the art and with the benefit of the present disclosure to select an appropriate method of network representation.

Several patterns and metrics may indicate that an ODA collection is high-quality and/or has an active community. For example, and without limitation, network representations like those of FIGS. 3, 5, 6, and 7 are likely to represent high-quality, trustworthy ODA collections with active communities. network representations like that of FIG. 4 are likely to represent low-quality, untrustworthy ODA collections with inactive communities. For example, in certain embodiments, one or more of asymmetric shape, multi-directional edges, wide variations in node ranks, high network connectivity, a high number of wallets/nodes, and the existence of spots of density (especially off-centered spots of density like that of FIG. 3) may indicate one or more of trustworthiness, high quality, and/or an active community. This list is purely exemplary and non-limiting.

FIG. 4 is a network visualization 400 illustrating untrustworthy ODA transactions between digital wallets, according to one or more embodiments of the present disclosure. network representations like those of FIG. 4 are likely to represent low-quality, untrustworthy ODA collections with inactive communities. For example, in certain embodiments, one or more of symmetric shape, uni-directional edges, low variation of node weights, the presence of a god node as the only source point or almost the only source point, or a lack of tangling (that is, exchange among the community after the initial drop) may indicate one or more of untrustworthiness, low quality, and/or an inactive community. This list is purely exemplary and non-limiting. In certain embodiments, the presence of a god node may indicate that airdrops and/or fake wallets could be involved in a scam orchestrated on behalf of the original owner/seller of the ODA collection.

In certain embodiments, additional efforts beyond the selection criteria discussed thus far may be needed to discern whether an ODA collection is high quality. For example, in the context of video games, in-game content (such as video game skins, weapons, vehicles, or other assets) may be transferred in the form of one or more ODAs. A network representation of these one or more ODAs may take the form of a wide collection of sparse linkages centering around a single (or near-single) god node. Though such a distribution would typically indicate a low-quality, untrustworthy collection, such a distribution is likely to be common in the context of video game assets even when the network visualization corresponds to a highly trustworthy source. Accordingly, in certain embodiments, context may be a necessary input when determining qualities of an ODA collection. Such embodiments are not limited to video game content. It is within the ability of those skilled in the art and with the benefit of the present disclosure to appropriately (1) modify the network visualization generation method; and/or (2) account for context in order to accurately assess one or more qualities of an ODA collection.

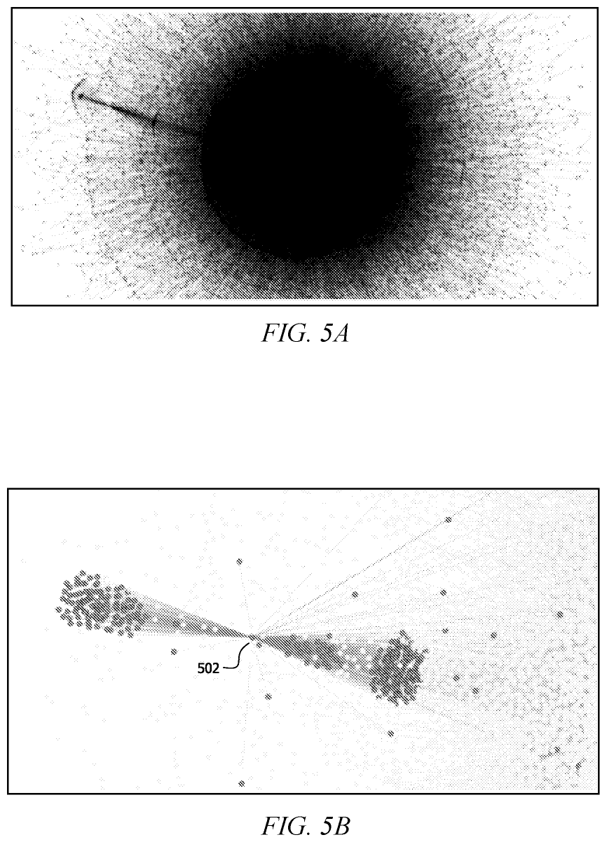

FIG. 5A is a second network visualization 500 illustrating trustworthy ODA transactions between digital wallets, according to one or more embodiments of the present disclosure. FIG. 5B is a subset of the second network visualization of FIG. 5A, illustrating a bowtie-shaped network visualization 502 of ODA transactions between digital wallets, according to one or more embodiments of the present disclosure. FIG. 5B's bowtie shape indicates a balance of transactions going into and out of the “bowtie's” central node. Such a shape may indicate that the node is not controlled by an individual—rather, “bowtie” nodes may indicate that the node is controlled by an organization or platform. The bowtie node of FIG. 5B is presented herein as an illustrative example of one of many shapes that may be interpreted to discern qualities of an ODA collection.

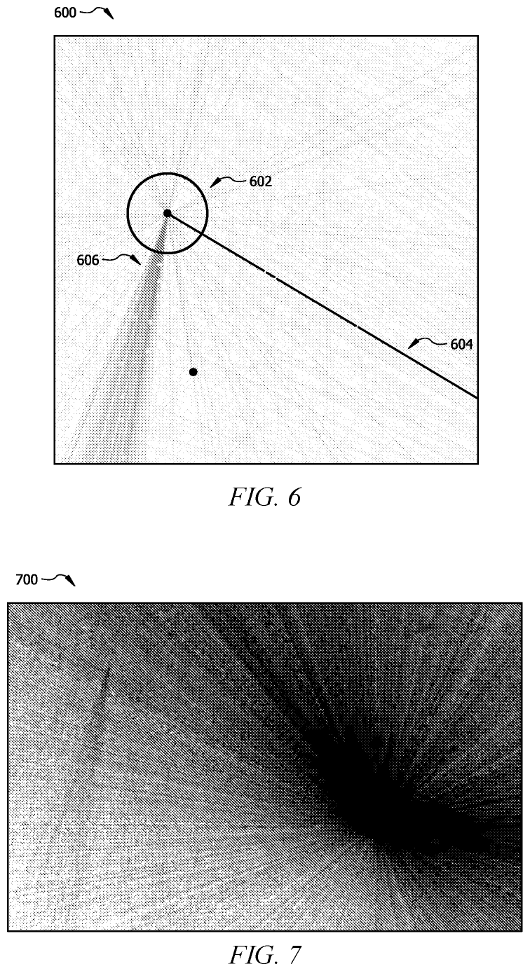

FIG. 6 is a third network visualization 600 illustrating trustworthy ODA transactions between digital wallets, according to one or more embodiments of the present disclosure. FIG. 6 shows, in relevant part, a single wallet node 602 receiving several NFTs from a single source 604 and distributing several NFTs to a plurality of sources 606. In certain embodiments, such a distribution may indicate that the central wallet node 606 is associated with a distribution-oriented entity, such as an investment fund that transacts using NFTs.

FIG. 7 is a fourth network visualization 700 illustrating trustworthy ODA transactions between digital wallets, according to one or more embodiments of the present disclosure. FIGS. 3-7 are purely exemplary; any network visualization of nodes transacting via ODAs falls within the scope of the present disclosure. The distributions of FIGS. 3, 5, 6, and 7 indicate a high-quality, trustworthy collection of ODAs. The distribution of FIG. 4 indicates a low-quality, untrustworthy collection of ODAs. In certain embodiments, an automated program may interpret one or more network visualizations to determine the quality of one or more ODA collections. In certain other embodiments, a person (such as an analyst or a user) may interpret one or more network visualizations to determine the quality of one or more ODA collections.

In certain embodiments, the network visualizations of FIGS. 3-7 may never be displayed on a user interface. Rather, in certain embodiments, characteristics associated with known shapes (or factors not associated with network visualizations) may be interpreted without displaying the network visualization. For example, in some embodiments, a dark distribution may indicate a high number of wallets, transactions, and/or ODA ownership. Accordingly, a dark distribution may indicate that the ODA collection is more likely to be high quality and/or trustworthy. In some embodiments, the system may interpret the underlying cause of a dark distribution—that is, a high number of wallets, transactions, and/or ODA ownership—and may thereby allow the practice of one or more methods of the present disclosure without displaying a network visualization. The “dark distribution” example of this paragraph is purely exemplary and non-limiting. Other characteristics of network distributions may be interpreted without displaying a network visualization without departing from the scope of the present disclosure.

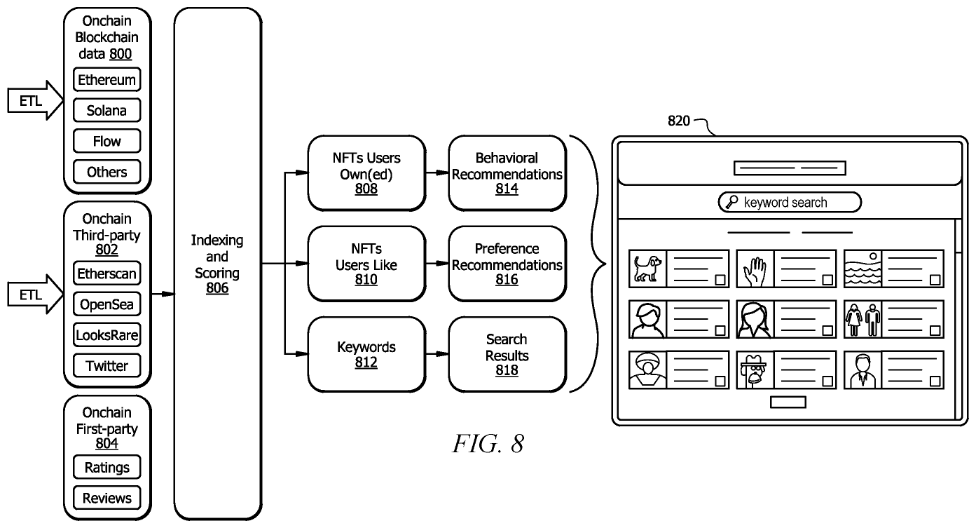

FIG. 8 is a block diagram illustrating the flow of data in an ODA recommendation system, according to one or more embodiments of the present disclosure. In certain embodiments, data may be integrated via one or more of onchain blockchain data 800, offchain third-party data 802, and/or offchain first-party data 804. Examples of onchain blockchain data sources 800 include Ethereum, Solana, Flow, other onchain blockchain data sources, and any combination thereof. Examples of offchain third-party data sources 802 include Etherscan, OpenSea, LooksRare, Twitter, other offchain third-party data sources, and any combination thereof. Examples of offchain first-party data sources 804 include ratings, reviews, other first-party data sources, and any combination thereof. In certain embodiments, integrated data may be indexed and scored 806 to evaluate one or more properties of one or more ODAs or ODA collections. Indexed and scored data 806 may be sorted based on perceptions of a user's preferences. For example, and without limitation, indexed and scored data 806 may be sorted based at least in part on one or more of a user's ODA ownership 808, ODAs the user has “liked” online 810, keywords entered by a user 812, other behavioral recommendations 814, other preference recommendations 816, other search results 818, any other appropriate factors, or any combination thereof. Finally, data corresponding to ODA recommendations based on one or more of ODA quality and perceived user preference may be displayed via a user interface 820. The letters “ETL” on the left side of FIG. 8 correspond to the words “Extract, Transform, and Load”; this term refers to data integration. The user interface 820 shown in FIG. 8 is purely exemplary, and any appropriate user interface may be used without departing from the scope of the present disclosure.

In certain embodiments, an ODA recommendation system may gather ownership data from a user's digital wallet. In certain embodiments, the user's ownership data may assist the ODA recommendation system in ascertaining the user's ODA preferences. For example, a user who owns several ODAs of a certain kind, in a certain artistic style, from a certain collection, from a certain creator, in a certain color, and/or of any other correlative characteristic may have a preference for ODAs that share that characteristic. Additionally, a user with a high total value of ODAs (including, and without limitation, cryptocurrencies) held in its digital wallet may be more inclined to purchase high-cost ODAs; inversely, a user with a lower total value of ODAs may be more inclined to purchase low-cost ODAs. These and other factors may be used to discern user preferences from a user's digital wallet. In certain embodiments, a user's preferences may influence the ODA recommendation system's recommendation(s). Any of the recommendation factors described in the present disclosure may be used alone or in conjunction with one or more other recommendation factors (including those not explicitly recited in the present disclosure) without departing from the scope of the present disclosure.

In certain embodiments, an ODA recommendation system may request one or more inputs from a user to discern the user's ODA preferences. For example, and without limitation, an ODA recommendation system may display one or more ODAs to a user and ask the user to rate the one or more ODAs. In certain embodiments, the rating may be a number (for example, and without limitation, a rating from one to ten). In certain embodiments, the rating may be a Boolean value, such as a “like” or “dislike.” In certain embodiments, the rating may be a ranking of ODAs. In certain embodiments, the ODA recommendation system may allow a user to select one or more ODAs that the user prefers out of a larger pool of ODA options. These and other techniques for discerning a user's preferences may be practiced without departing from the scope of the present disclosure. In certain embodiments, a user's preferences may influence the ODA recommendation system's recommendation(s).

In certain embodiments, an ODA recommendation system may allow a user to search for ODAs. In certain embodiments, a user's search input may influence the ODA recommendation system's recommendation(s). In certain embodiments, a user's search history may influence the ODA recommendation system's recommendation(s).

In certain embodiments, an ODA recommendation system may use a network interface to receive ownership data through a plurality of nodes. The ODA system may use a processor to generate a network distribution of node weights based at least in part on the ownership data. In certain embodiments, generating the network distribution of node weights may comprise generating and displaying a network visualization. In certain other embodiments, generating the network distribution may comprise determining one or more attributes of an ODA collection based on known data patterns without ever displaying the network visualization. In certain embodiments, a processor may determine an ODA recommendation based at least in part on the network distribution (regardless of whether a network visualization was displayed). In certain embodiments, the network interface may send a user one or more ODA recommendations. In certain embodiments, the one or more ODA recommendations may be based at least in part on ownership data and/or the user's preferences (including, and without limitation, the user's stated preferences, ODA ownership, digital wallet value, and/or search history).

In certain embodiments, one or more ownership data metrics may impact the ODA recommendations. For example, and without limitation, one or more of the following wallet-level ownership data metrics may impact the ODA recommendations: visual rank, indegree, outdegree, sink, flow, percent of tokens allowed, “dabbler score,” and “volume score.” As used herein, the term “visual rank” refers to any automated process that may extract conclusions via the visualizable shape of a network distribution. One example of visual rank is Google's “PageRank,” an open-source software wherein each vertex (or as used herein, each ODA transaction) of a graph may be measured for its importance. Indegree is the number of arcs (or transactions) coming into a wallet (that is, purchases or other receipts of ODAs). Outdegree is the number of arcs (or transactions) coming out of a wallet (that is, sales or other divestments of ODAs). Sink is equal to in degrees divided by out degrees. Flow is equal to out degrees divided by in degrees. Percent of tokens allowed is equal to the number of unique token owners divided by the number of times a specific token has been transferred. Dabbler score is the average number of transactions per wallet that a virtual wallet has transacted with. Volume score is the average number of collections per wallet that a virtual wallet has transacted with.

In certain embodiments, one or more collection-level ownership data metrics may impact the ODA recommendations. For example, and without limitation, one or more of the following collection-level ownership data metrics may impact the ODA recommendations: mean visual rank, mean indegrees, mean outdegrees, standard deviation of visual rank, standard deviation of in degrees, standard deviation of out degrees, mean sink, mean flow, percent difference between floor price and average price, mean dabbler score, mean volume score, “newbie rate,” number of unique tokens, number of unique wallets, total transactions, average number of transactions for a token in the collection, maximum number of transactions for a token in the collection, minimum number of transactions for a token in the collection, average number of unique owners for a token in the collection, maximum number of unique owners for a token in the collection, minimum number of unique owners for a token in the collection, average percentage of unique owners to the number of transfers for a token in the collection (that is, the average of the number of unique token owners divided by the number of times that specific token has been transferred), maximum percentage of unique owners to the number of transfers for a token in the collection, minimum percentage of unique owners to the number of transfers for a token in the collection, time that has passed since the collection appeared on the blockchain, time from the collection appearing on the blockchain to the first transfer of a token within the collection, number of current owners that did not mint the collection, number of current owners that minted the collection, total number of tokens that appear on the blockchain, percent of current owners that minted the collection, average age of wallet that has transacted with the collection, average number of unique collections per wallet that has transacted with the collection, average number of unique tokens per wallet that has transacted with the collection, average number of total token transactions per wallet that has transacted with the collection, average percent of unique token transactions per wallet divided by total token transactions, percent of tokens owned, percent difference between average price and minimum price of a token in the collection, average number of transfers per token divided by days active (wherein “days active” is the number of days on which a collection was involved in one or more transactions), days active divided by total days since mint, total value transferred in transactions involving the collection, number of current owners divided by total transfers, clustering coefficient, and tokens-to-transactions ratio. The list of ownership data metrics provided in this paragraph and the preceding paragraph are purely exemplary and non-limiting; other ownership data metrics may be used without departing form the scope of the present disclosure, and the ownership data metrics may be used in isolation or in any combination. The ownership data metrics may be weighted, averaged, and/or aggregated to produce a derivative score. It is within the ability of one skilled in the art and with the benefit of the present disclosure to select appropriate ownership data metrics.

The tokens-to-transactions ratio is equal to the number of tokens in the collection divided by the number of transactions of tokens in the collection. In certain embodiments, a high tokens-to-transactions ratio may indicate that the NFT/ODA may be unpopular. The “newbie rate” is the total number of unique wallets that have transacted with the collection divided by the sum of unique senders and receivers. In certain embodiments, a high newbie rate may indicate that there may be one or more collections with very low floor prices. The clustering coefficient is the number of triangles that exist in a given graph divided by the number of triangles that could exist. In certain embodiments, a clustering coefficient may be used to determine the degree of transactional connectivity between wallets.

In certain embodiments, an ODA recommendation system may incorporate data from a third-party source, such as OpenSea, Etherscan, LooksRare, Twitter, another third-party source, or any combination thereof. For example, and without limitation, a determination of whether OpenSea has verified the collection may be used as an input in one or more embodiments of the present disclosure. This example is purely exemplary and non-limiting; any appropriate third-party data may be used without departing from the scope of the present disclosure.

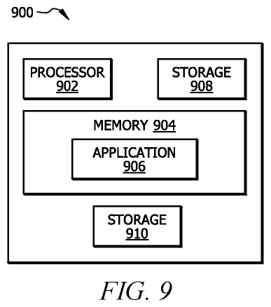

FIG. 9 is a block diagram illustrating components of an example control server, according to one or more embodiments of the present disclosure. Control server 900 may refer to any computing system for performing the algorithms and communications described herein, and may include processor 902, storage 908, interface 910, and memory 904. In some embodiments, control server 900 may refer to any suitable combination of hardware and/or software implemented in one or more modules to process data and provide the described functions and operations. In some embodiments, the functions and operations described herein may be performed by a pool of control servers 900. The algorithms described herein may be performed by one or more control servers, such as the control server illustrated in FIG. 9.

Memory 904 may refer to any suitable device capable of storing and facilitating retrieval of data and/or instructions. Examples of memory 904 include computer memory (for example, Random Access Memory (“RAM”) or Read Only Memory (“ROM”)), mass storage media (for example, a hard disk), removable storage media (for example, a Compact Disk (“CD”) or a Digital Video Disk (“DVD”)), database and/or network storage (for example, a server), and/or or any other volatile or non-volatile, non-transitory computer-readable memory devices that store one or more files, lists, tables, or other arrangements of information. Although FIG. 9 illustrates memory 904 as internal to control server 900, memory 904 may be internal or external to control server 900, depending on particular implementations. Also, memory 904 may be separate from or integral to other memory devices to achieve any suitable arrangement of memory devices.

Memory 904 is generally operable to store one or more applications 906. Application(s) 906 generally refer to logic, rules, algorithms, code, tables, and/or other suitable instructions for performing a particular application described herein.

Processor 902 is communicably coupled to memory 904. Processor 902 is generally operable to execute application 906 stored in non-transitory form in memory 904. Processor 902 may comprise any suitable combination of hardware and software to execute instructions and manipulate data to perform the described functions for control server 900. In some embodiments, processor 902 may include, for example, one or more computers, one or more central processing units (“CPUs”), one or more microprocessors, one or more applications, and/or other logic.

Storage 908 is communicably coupled to processor 902. In some embodiments, storage 908 may refer to any suitable device capable of storing and/or facilitating retrieval of data and/or instructions. Examples of storage 908 include computer memory (for example, RAM or ROM), mass storage media (for example, a hard disk), removable storage media (for example, a CD or a DVD), database and/or network storage (for example, a server), and/or or any other volatile or non-volatile, non-transitory computer-readable memory devices that store one or more files, lists, tables, or other arrangements of information. Storage 908 may store data, such as contract data, device performance data, etc.

In some embodiments, interface 910 is communicably coupled to processor 902 and may refer to any suitable device operable to receive input for control server 900, send output from control server 900, perform suitable processing of the input or output or both, communicate to other devices, or any combination of the preceding. Interface 910 may include appropriate hardware (for example, and without limitation, a modem, network interface card, etc.) and software, including protocol conversion and data processing capabilities, to communicate through a network or other communication system that allows control server 900 to communicate to other components of the system. Interface 910 may include any suitable software operable to access data from various devices such as components of nodes or other components such as Etherscan, OpenSea, LooksRare, Twitter, or other offchain third-party data sources. In some embodiments, an ODA recommendation system may include machine learning software systems and/or user interface applications. The system may have the ability to register new devices or new members onto a network to automatically include one or more elements of user data for use in determining ODA quality and/or user preferences.

In some embodiments, a server 900 may be operable to store a user account associate with a user. A processor 902 may be communicatively coupled to the memory 904. In certain embodiments, an application 906 stored by the memory 904 may cause the processor 902 to receive ODA ownership data through a plurality of nodes. In certain embodiments, an application 906 may cause the processor 902 to generate a network visualization of node weights. In certain embodiments, the network visualization of may be “generated” within the meaning of the present disclosure without ever displaying the network visualization on a user interface. In certain embodiments, the application 906 may cause the processor 902 to determine an ODA recommendation based on one or more of ownership data and perceived user preferences. In certain embodiments, the application 906 may cause the processor 902 to send recommendation data to a user.

While various embodiments were provided in the foregoing description, those skilled in the art may make modifications and alterations to these aspects without departing from the scope and spirit of the invention. For example, it is to be understood that this disclosure contemplates that, to the extent possible, one or more features of any aspect can be combined with one or more features of any other aspect. Accordingly, the foregoing description is intended to be illustrative rather than restrictive. The invention described hereinabove is defined by the appended claims, and all changes to the invention that fall within the meaning and the range of equivalency of the claims are to be embraced within their scope.

What is claimed is:

1. A system for determining one or more qualities of an ownable digital asset, comprising:
at least one distributed blockchain network comprising a plurality of nodes; and
a blockchain analysis system comprising:
a processor; and
a non-transitory computer readable medium for storing one or more instructions that, when executed, cause the processor to:
receive ownership data corresponding to ownership of one or more ownable digital assets through the plurality of nodes;
generate a network distribution of node weights based at least in part on the ownership data;
determine an ownable digital asset recommendation based at least in part on one or more factors, the one or more factors comprising a first factor based at least in part on the network distribution of node weights; and
send recommendation data to a user corresponding to the ownable digital asset recommendation.

2. The system of claim 1, wherein the one or more factors further comprise one or more of:
data received from a user node corresponding to the user; and
one or more user inputs.

3. The system of claim 2, wherein the one or more user inputs correspond to one or more of the user's stated preferences and the user's search history.

4. The system of claim 2, wherein the data received from the user node corresponds to one or more of the user's history of ownable digital asset ownership and an economic value of the user's digital wallet.

5. The system of claim 1, wherein the recommendation data comprises a ranking of ownable digital assets.

6. The system of claim 1, wherein the ownership data is received, at least in part, by discovering nodes through an initial sample of seed nodes.

7. The system of claim 1, wherein the network distribution is not displayed on a user interface.

8. The system of claim 1, wherein the ownable digital asset is a non-fungible token.

9. A method comprising:
receiving, using a network interface, ownership data corresponding to ownership of one or more ownable digital assets through a plurality of nodes;
generating, using a processor, a network distribution of node weights based at least in part on the ownership data;
determining, using the processor, an ownable digital asset recommendation based at least in part on one or more factors, the one or more factors comprising a first factor based at least in part on the network distribution of node weights; and
sending to a user, using the network interface, recommendation data corresponding to the ownable digital asset recommendation.

10. The method of claim 9, wherein the one or more factors further comprise one or more of:
data received from a user node corresponding to the user; and
one or more user inputs.

11. The method of claim 10, wherein the one or more user inputs correspond to one or more of the user's stated preferences and the user's search history.

12. The method of claim 10, wherein the data received from the user node corresponds to one or more of the user's history of ownable digital asset ownership and an economic value of the user's digital wallet.

13. The method of claim 9, wherein the recommendation data comprises a ranking of ownable digital assets.

14. The method of claim 9, wherein the ownership data is received, at least in part, by discovering nodes through an initial sample of seed nodes.

15. The method of claim 9, wherein the network distribution is not displayed on a user interface.

16. A server comprising:
a memory operable to:
store a user account associated with a user; and
a processor communicatively coupled to the memory, the memory including executable instructions that, upon execution by the processor, cause the server to:
receive ownership data corresponding to ownership of one or more ownable digital assets through a plurality of nodes;
generate a network distribution of node weights based at least in part on the ownership data;
determine an ownable digital asset recommendation based at least in part on one or more factors, the one or more factors comprising a first factor based at least in part on the network distribution of node weights; and
send recommendation data to a user corresponding to the ownable digital asset recommendation.

17. The server of claim 16, wherein the one or more factors further comprise one or more of:
data received from a user node corresponding to the user; and
one or more user inputs.

18. The server of claim 17, wherein the one or more user inputs correspond to one or more of the user's stated preferences and the user's search history.

19. The server of claim 17, wherein the data received from the user node corresponds to one or more of the user's history of ownable digital asset ownership and an economic value of the user's digital wallet.

20. The server of claim 16, wherein the recommendation data comprises a ranking of ownable digital assets.

21. The server of claim 16, wherein the ownership data is received, at least in part, by discovering nodes through an initial sample of seed nodes.

22. The server of claim 16, wherein the network distribution is not displayed on a user interface.

23. The server of claim 16, wherein the ownable digital asset is a non-fungible token.
